(19) United States
(12) Patent Application Publication
(10) Pub. No.: US 2015/0356173 A1
(43) Pub. Date: Dec. 10, 2015

(54) SEARCH DEVICE

(71) Applicants: Takeyuki AIKAWA, (US); Yusuke KOJI, (US)

(72) Inventors: Takeyuki AIKAWA, Chiyoda-ku (JP); Yusuke KOJI, Chiyoda-ku (JP)

(73) Assignee: MITSUBISHI ELECTRIC CORPORATION, Chiyoda-ku, Tokyo (JP)

(21) Appl. No.: 14/762,125

(22) PCT Filed: Mar. 4, 2013
(86) PCT No.: PCT/JP2013/055826

§ 371 Date: Jul. 20, 2015

(51) Int. Cl. G06F 17/30

(52) U.S. Cl. CPC G06F 17/30693; G06F 17/30616; G06F 17/30684

(57) ABSTRACT

A search device includes: a similar word candidate acquirer including a word dictionary searcher to perform a comparison between an input character string and word character string data, and search for word character string data similar to the input character string to acquire, as similar word candidates, the word character string data, and a number-of-similar-word-candidates controller to select similar word candidates from the similar word candidates according to a preset threshold; a similar word selector to calculate an edit distance between each of the similar word candidates selected and the input character string, and select, as a similar word, a similar word candidate whose edit distance is equal to or less than a predetermined distance; and a name searcher to refer to a name search index data storage to search for a search text including the similar word selected by the similar word selector.

### FIELD OF THE INVENTION

The present invention relates to a search device that performs an ambiguous search through the inside of data registered in advance by using, as a search key, not only an official name but also an abbreviation, a half-remembered name, or the like.

### BACKGROUND OF THE INVENTION

There is a case in which when searching for an address or a facility name by using a search device, the user does not necessarily remember its exact name, but causes the search device to perform a search by using, as a search key, a common name, an abbreviation, a half-remembered incorrect name or the like. Further, in a terminal or equipment, such as a car navigation device or a smart phone, which does not have a keyboard as an input device, there is a case in which a search is performed on the basis of a result of having performed voice recognition on a voice signal inputted via a microphone, a result of having performed character recognition on an input done via a touch panel, or the like. In the case of an input using either one of these input devices, there exists an input error caused by a failure of the user, such as a recognition error or a keying error.

In either of the case in which a common name, an abbreviation, a half-remembered incorrect name or the like is used as a search key, and the case in which an input error caused by the user exists, a technique of performing an ambiguous search for not only an official name but also a name whose character string or pronunciation is similar to that of its official name is required.

As a technique of performing an ambiguous search, for example, patent reference 1 is disclosed. In patent reference 1, a technique of searching for similar word candidates by using the matching degree of a partial character string from an inputted key word, further extracting a similar word having a shorter edit distance with the input keyword from these similar words candidates, and performing an ambiguous preamble search by adding the similar word as a search keyword is disclosed.

For example, when “acetaldehyde” is inputted as a search keyword, similar word candidates including “acet”, “alde”, and “hyde” which are partial character strings, e.g., similar words candidates, such as “acetaldeyde” and “acetaldol”, are searched for. Next, by calculating an edit distance between the input keyword “acetaldehyde” and each of the similar word candidates, and then performing a full-text search by using a similar word “acetaldeyde” having a smaller edit distance among the similar word candidates, search omissions are prevented.

### RELATED ART DOCUMENT

### Patent Reference

Patent reference 1: Japanese Unexamined Patent Application Publication No. 2005-11078

### SUMMARY OF THE INVENTION

### Problems to be Solved by the Invention

A problem with the technique disclosed in above-mentioned patent reference 1 is, however, that the calculation cost of the edit distance is very large, and, when many similar word candidates exist, a longer calculation time is required. In patent reference 1, while the similar words candidates are narrowed down in advance by using the matching degrees of their partial character strings, there is a problem that it is difficult to calculate an edit distance for each of many similar word candidates in such a way that search omissions do not occur in an embedded device such as a car navigation device.

Another problem with the technique disclosed in above-mentioned patent reference 1 is that because the number of input characters and the number of input words which affect the ambiguity at the time of performing a similarity search are not taken into consideration, it is difficult to make the search accuracy and the search speed performance compatible with each other according to these parameters.

A further problem with the technique disclosed in above-mentioned patent reference 1 is that because only words whose appearances when written resemble each other are targeted at the time of performing a search for similar word candidates, it is difficult to perform a search for a similar word whose similarity in its appearance when written is small due to a keying error or a voice recognition error. A still further problem is that because the similarity between similar word candidates is not taken into consideration in the full-text search process, there is a possibility that an unnecessary full-text search process is repeated, and it is therefore difficult to speed up the search process.

The present invention is made in order to solve the above-mentioned problems, and it is therefore an object of the present invention to provide a search device that prevents search omissions and implements a high-speed search process, and that also implements a search process in consideration of a balance between the prevention of search omissions and a speedup of the process.

### Means for Solving the Problem

In accordance with the present invention, there is provided a search device including: a word dictionary to store word character string data about each of words into which a search text is divided; a similar word candidate acquirer including a word dictionary searcher to perform a comparison between an input character string and word character string data stored in the word dictionary, and search for word character string data similar to the input character string to acquire, as similar word candidates, the word character string data which are searched for, and a number-of-similar-word-candidates controller to select similar word candidates from the similar word candidates acquired by the word dictionary searcher according to a preset threshold; a similar word selector to calculate an edit distance between each of the similar word candidates selected by the number-of-similar-word-candidates controller and the input character string, and select, as a similar word, a similar word candidate whose calculated edit distance is equal to or less than a predetermined distance; a search index data storage to store the search text; and a text searcher to refer to the search index data storage to search for a search text including the similar word selected by the similar word selector.

### Advantages of the Invention

According to the present invention, a high-speed search process which prevents search omissions can be performed, and a search process in consideration of a balance between the prevention of search omissions and a speedup of the process can also be performed.

### BRIEF DESCRIPTION OF THE FIGURES

FIG. 1 is a block diagram showing the configuration of a search device in accordance with Embodiment 1;

FIG. 2 is a flow chart showing the operation of the search device in accordance with Embodiment 1;

FIG. 3 is a block diagram showing the configuration of the search device in accordance with Embodiment 1 which processes a plurality of words;

FIG. 4 is a flow chart showing the operation of the search device in accordance with Embodiment 1 which processes a plurality of words;

FIG. 5 is a block diagram showing the configuration of a similar word candidate acquirer and a word dictionary of the search device in accordance with Embodiment 1;

FIG. 6 is a diagram showing an example of a specific character string table of the search device in accordance with Embodiment 1;

FIG. 7 is a diagram showing an example of a word character string table and a character string bigram index of the search device in accordance with Embodiment 1;

FIG. 8 is a flow chart showing the operation of a similar word candidate acquirer of the search device in accordance with Embodiment 1;

FIG. 9 is a block diagram showing the configuration of a similar word selector of the search device in accordance with Embodiment 1;

FIG. 10 is a flow chart showing the operation of the similar word selector of the search device in accordance with Embodiment 1;

FIG. 11 is a block diagram showing the configuration of a name search index data storage of the search device in accordance with Embodiment 1;

FIG. 12 is a diagram showing an example of a namelist of the search device in accordance with Embodiment 1;

FIG. 13 is a block diagram showing the configuration of a search device in accordance with Embodiment 2;

FIG. 14 is a flow chart showing the operation of the search device in accordance with Embodiment 2;

FIG. 15 is a block diagram showing the configuration of a similar word candidate acquirer and a word dictionary of the search device in accordance with Embodiment 2;

FIG. 16 is a flow chart showing the operation of a similar word candidate expansion searcher of the search device in accordance with Embodiment 2;

FIG. 17 is a diagram showing an example of a similar character string weight table of the search device in accordance with Embodiment 2;

FIG. 18 is a block diagram showing the configuration of a search device in accordance with Embodiment 3;

FIG. 19 is a flow chart showing the operation of the search device in accordance with Embodiment 3; and

FIG. 20 is a flow chart showing the operation of a similar word integrator of the search device in accordance with Embodiment 3.

### EMBODIMENTS OF THE INVENTION

Hereafter, in order to explain this invention in greater detail, the preferred embodiments of the present invention will be described with reference to the accompanying drawings.

Although, as to a search device in accordance with the present invention, a facility name search in car navigation will be explained as an example hereafter, the present invention is not limited to a facility name search in car navigation, and can be applied to search processes in general which are performed in embedded devices, such as a search for an address and a search for an electronic manual.

### Embodiment 1

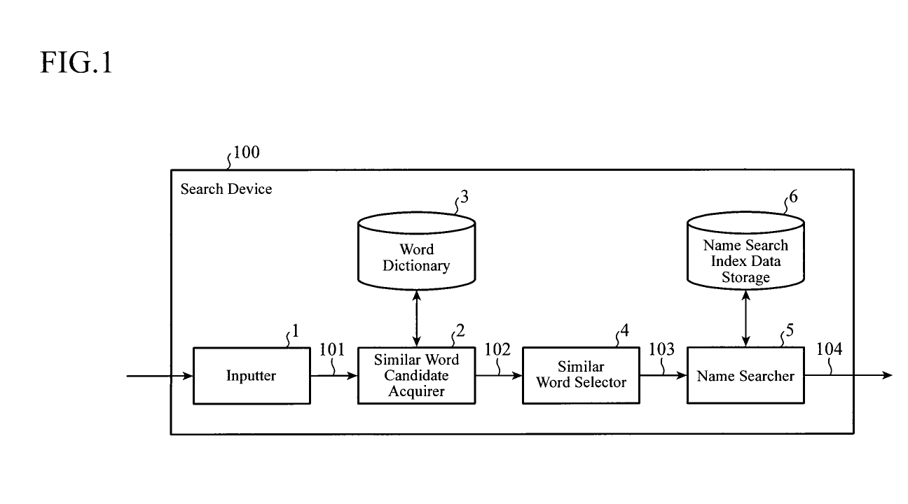

FIG. 1 is a block diagram showing the configuration of a search device in accordance with Embodiment 1 of the present invention.

The search device 100 is configured with an inputter 1, a similar word candidate acquirer 2, a word dictionary 3, a similar word selector 4, a name searcher (text searcher) 5, and a name search index data storage (search index data storage) 6.

The inputter 1 is configured with a software keyboard, a voice recognition function, etc., and accepts an input operation performed by a user and converts the input operation accepted thereby into an input character string 101. The similar word candidate acquirer 2 refers to the word dictionary 3 to acquire a similar word candidate list 102 for the input character string 101. The similar word selector 4 calculates similarity which is based on an edit distance between each candidate in the similar word candidate list 102, which is acquired by the similar word candidate acquirer 2, and the input character string 101, and selects a similar word list 103 which will be used in a next-stage process. The name searcher 5 refers to name search index data stored in the name search index data storage 6, and outputs, as search result data 104, name data (search text) including each of the words in the similar word list 103. The name search index data storage 6 stores the name search index data therein.

Next, the operation of the search device 100 will be explained.

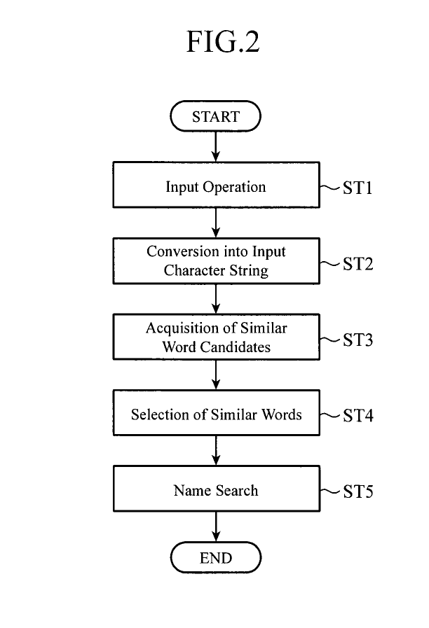

FIG. 2 is a flow chart showing the operation of the search device in accordance with Embodiment 1 of the present invention.

When an input operation is performed (step ST1), the inputter 1 converts the input operation into an input character string 101 (step ST2). The similar word candidate acquirer 2 refers to the word dictionary 3 to acquire similar word candidates for the input character string 101 and generate a similar word candidate list 102 (step ST3). At that time, in order to also enable an input for a complement to a word, the similar word candidate acquirer refers to the word dictionary and performs an ambiguous comparison based on prefix search priority to acquire similar word candidates. The word dictionary 3 is generated by dividing each name data which is a search target into words in advance and removing redundancy. In this similar word candidate acquiring process of step ST3, the similar word candidate acquirer retrieves similar word candidates according to an algorithm whose amount of computations is smaller than that of an edit distance calculation and which can speed up the process. The details of the similar word candidate acquiring process of step ST3 will be mentioned below.

The similar word selector 4 acquires the similar word candidate list 102 which consists of the similar word candidates acquired, in step ST3, by the similar word candidate acquirer 2, calculates a degree of similarity based on the edit distance between each of all the similar word candidates in the similar word candidate list 102 and the input character string 101, and selects similar word candidates each of which has a degree of similarity equal to or greater than a predetermined degree of similarity to generate a similar word list 103 (step ST4). The name searcher 5 refers to the index data stored in the name search index data storage 6 to search for name data each including either one of the words in the similar word list 103 generated in step ST4, and outputs the name data as search result data 104 (step ST5). The details of the name search process of step ST5 will be mentioned below.

As mentioned above, there are advantages as will be mentioned below in separately performing the process of acquiring similar words of step ST3 and the process of selecting similar words of step ST4, and the process of searching for a name which consists of a plurality of words of step ST5.

First, as to the ambiguous search process which results in a large index data volume and a large amount of computations, i.e., the processes of acquiring similar words and of selecting similar words, by configuring the former processes as processes based on words, the number of target data can be reduced, and increase in the data volume and increase in the amount of computations can be prevented. On the other hand, as to the latter name search process which results in large increase in the number of search targets, by configuring this process as a simple prefix search process without performing an ambiguous search, the process can be performed while importance is placed on the speed performance and the memory performance.

Although the explanation is made in above-mentioned FIGS. 1 and 2 for the sake of simplicity by assuming that the input character string 101 is one word or a partial character string of one word, the input character string 101 can be alternatively be a plurality of words or a partial character string of a plurality of words.

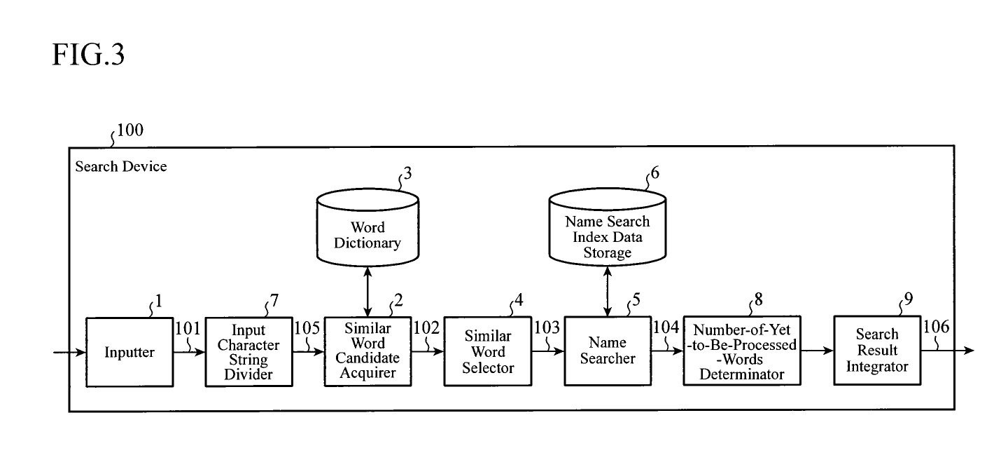

FIG. 3 is a block diagram showing the configuration of another example of the search device in accordance with Embodiment 1 of the present invention, and shows a configuration in a case of processing the input character string 101 which is a plurality of words. The same components as those of the search device 100 shown in FIG. 1 are designated by the same reference numerals as those shown in FIG. 1, and the explanation of the components will be omitted hereafter.

The input character string divider 7 divides the input character string 101 according to word delimiters such as blanks, to generate an after-division input character string 105 which consists of a plurality of character strings. The after-division input character string 105 consists of individual character strings and word numbers after division. The similar word candidate acquirer 2, the similar word selector 4, and the name searcher 5 perform the processes shown in the flow chart of FIG. 2 on the individual character strings into which the input character string is divided by the input character string divider 7.

The number-of-yet-to-be-processed-words determinator determines whether or not the processes on all the character strings which construct the after-division input character string 105 are completed. The search result integrator 9 integrates search results for all the character strings which construct the after-division input character string 105, and outputs integrated search result data 106.

Next, an operation of performing the search process on the input character string 101 which is a plurality of words will be explained.

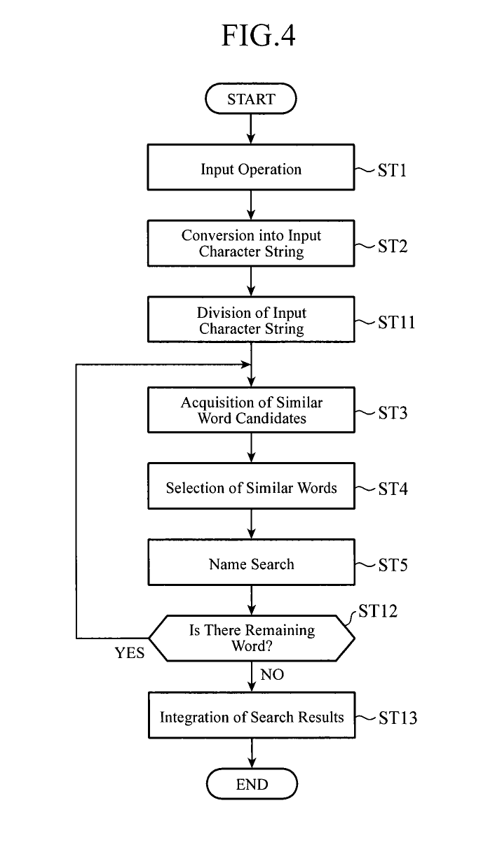

FIG. 4 is a flow chart showing the other operation of the search device in accordance with Embodiment 1, and shows the operation of performing the search process on the input character string 101 which is a plurality of words. The same steps as those of the search device 100 shown in FIG. 2 are designated by the same reference characters as those shown in FIG. 2, and the explanation of the steps will be omitted hereafter.

After the inputter 1, in step ST2, converts the input operation into the input character string 101, the input character string 101 divides the input character string divider 7 according to word delimiters such as blanks, to generate an after-division input character string 105 (step ST11). The processes of ST3 to ST5 are repeatedly performed on each of the character strings which construct the after-division input character string 105, and results are stored in a storage area (not shown).

The number-of-yet-to-be-processed-words determinator 8 determines the number of target words on each of which the repetitive processes of steps ST3 to ST5 are to be performed, to determine whether a remaining word on which the repetitive processes are to be performed exists (step ST12). When a remaining word on which the repetitive processes are to be performed exists (when YES in step ST12), the search device returns to the process of step ST3 and repeats the above-mentioned processes. In contrast, when no remaining word on which the repetitive processes are to be performed exists (when NO in step ST12), the search result integrator 9 integrates the search results acquired through the repetitive processes of steps ST3 to ST5, outputs integrated search result data 106 (step ST13), and ends the processing.

In the integrating process of step ST13, the search result integrator eliminates a redundant result by using a name ID included in each search result data 104. Further, by making a comparison among a plurality of word character strings included in each name data which is a search result by using the word numbers provided for the after-division input character string 105, the search result integrator can also perform ranking in consideration of the order in which the words have been inputted. Although the following explanation will be made as to the processing on the input character string 101, the processing on each character string of the after-division input character string 105 is similarly performed as mentioned above.

Next, the details of the similar word candidate acquirer 2 will be explained. Hereafter, a method of performing an ambiguous comparison at a high speed while using, as an index, a character bigram with character position information will be explained. As long as the method is an ambiguous search method which can be executed at a higher speed than that at which the similar word selecting process (the process of step ST4 in the flow charts of FIGS. 2 and 4) based on the edit distance, which will be mentioned below, is performed, and which can approximate an edit distance calculation result, the method does not impair the features of the present invention.

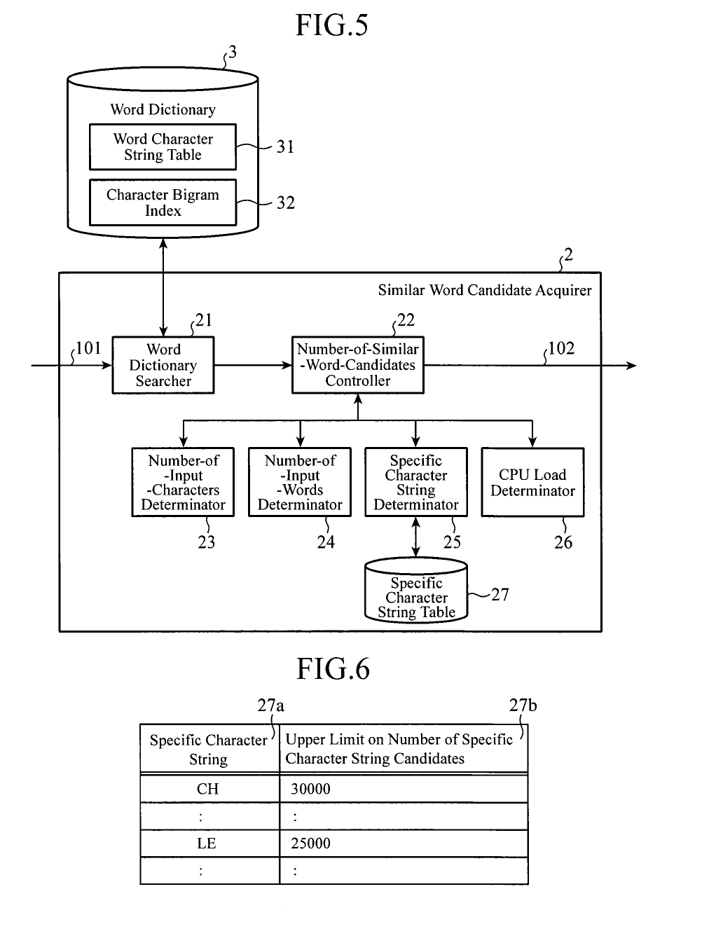

FIG. 5 is a block diagram showing the configuration of the similar word candidate acquirer and the word dictionary of the search device in accordance with Embodiment 1 of the present invention.

The similar word candidate acquirer 2 is configured with a word dictionary searcher 21, a number-of-similar-word-candidates controller 22, a number-of-input-characters determinator 23, a number-of-input-words determinator 24, a specific character string determinator 25, a CPU load determinator 26, and a specific character string table 27. Further, the word dictionary 3 to which the word dictionary searcher 21 refers is configured with a word character string table 31 and a character bigram index 32. The specific character string table 27 can be configured outside the similar word candidate acquirer 2.

In order to also enable an input for interpolation of a word, the word dictionary searcher 21 refers to the word dictionary 3 and performs an ambiguous comparison based on prefix search priority, to acquire similar word candidates. The number-of-similar-word-candidates controller 22 determines a final upper limit N on the final number of candidates on the basis of upper limits n(s) on the number of candidates, the upper limits being calculated by the number-of-input-characters determinator 23, the number-of-input-words determinator 24, the specific character string determinator 25, and the CPU load determinator 26, and selects the top N results of the word dictionary search results provided by the word dictionary searcher 21, to generate and output a similar word candidate list 102.

The number-of-input-characters determinator 23 determines the number of input characters of the input character string 101, and calculates the upper limit n on the number of candidates on the basis of the result of the determination. The number-of-input-words determinator 24 determines the number of input words of the input character string 101, and calculates the upper limit n on the number of candidates on the basis of the result of the determination. The specific character string determinator 25 refers to the specific character string table 27 and determines whether the input character string 101 matches a specific character string, and acquires the upper limit n on the number of candidates corresponding to the specific character string, which is defined in the specific character string table 27 in advance, on the basis of the result of the determination. The CPU load determinator 26 determines the CPU load (arithmetic load) on the search device 100 at the time of performing the search process, and calculates the upper limit n on the number of candidates on the basis of the result of the determination.

The specific character string table 27 is a table for dealing with specific character strings each having an extremely large number of similar word candidates, character strings each of which is known in advance to, in contrast to specific character strings, have a small number of similar candidates, etc.

FIG. 6 is a diagram showing an example of the specific character table of the search device in accordance with Embodiment 1 of the present invention.

The specific character string table 27 is a table showing a correspondence between each specific character string 27a and the upper limit 27b on the number of specific character string candidates.

Next, the word dictionary 3 will be explained. The word dictionary 3 is configured with the word character string table 31 and the character bigram index 32, and is generated by dividing each name data which is a search target into words in advance, and then removing redundancy.

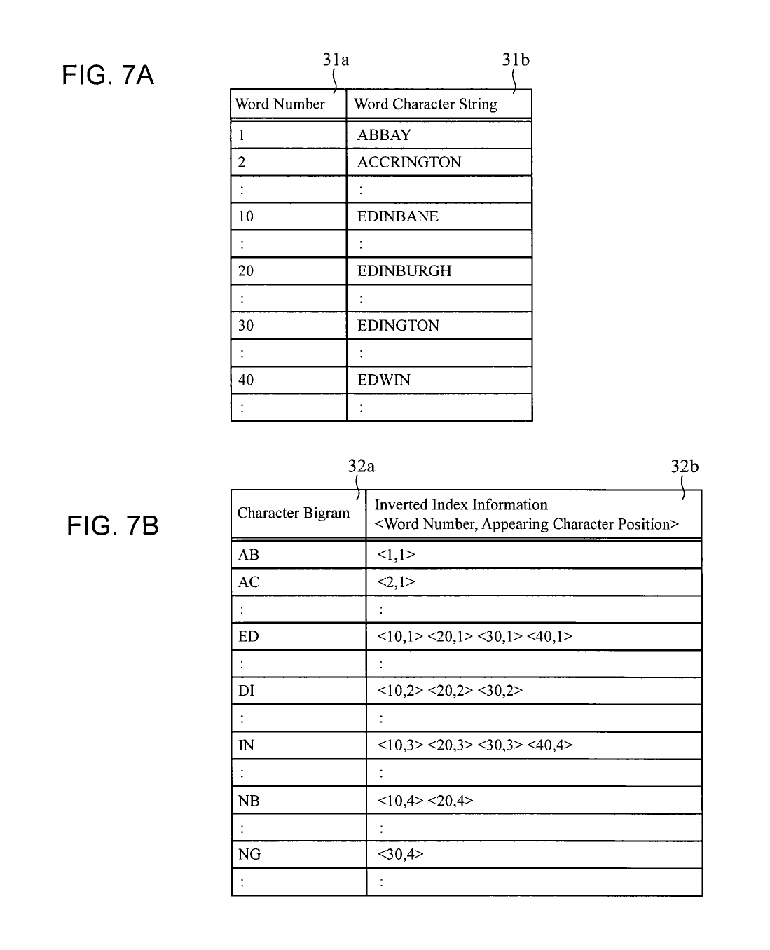

FIG. 7 is a diagram showing an example of storing of the word dictionary storage of the search device in accordance with Embodiment 1 of the present invention, and FIG. 7(a) shows an example of the word character string table and FIG. 7(b) shows an example of the character bigram index.

The word character string table 31 is a table showing a correspondence between each word number 31a and a word character string 31b. The character bigram index 32 is index data in which each character bigram 32a which is one of parts into which each word is divided and which consists of two characters, and inverted index information 32b are stored while they are brought into correspondence with each other. Each inverted index information 32b consists of the word number of a character bigram 32a and an appearing character position. By using the index data in the character bigram index 32, from the partial character strings each of which is one of parts into which the input character string 101 is divided, each of the parts consisting of two characters, a word in which each of the partial character strings appears at a similar position can be searched for at a high speed.

Next, the details of the similar word candidate acquiring process performed by the similar word candidate acquirer 2 will be explained.

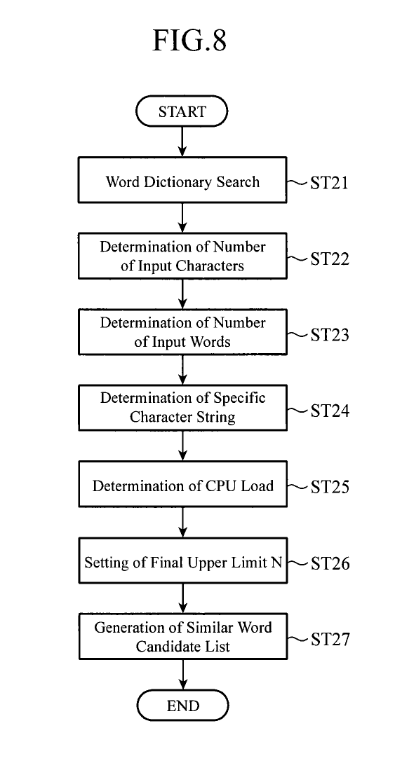

FIG. 8 is a flow chart showing the operation of the similar word candidate acquirer of the search device in accordance with Embodiment 1 of the present invention. The word dictionary searcher 21 refers to the word dictionary 3, and searches for words similar to the input character string 101 (step ST21). Concretely, the word dictionary searcher divides the input character string 101 into parts each of which consists of two characters, and refers to the character bigram index 32 shown in FIG. 7(b), to extract pairs of the number of a word including each character bigram, which is acquired from the input character string 101, and an appearing character position.

For example, it is assumed that “EDINB” is provided as the input character string 101. The word dictionary searcher 21 divides the input character string 101 into parts each of which consists of two characters first, to acquire the following four kinds of character bigrams: “ED”, “DI”, “IN”, and “NB.” For each of the character bigrams, <10, 1>, <20, 1>, and <10, 2>, <20, 2>, etc. which are pairs of a word number and an appearing character position are acquired from the bigram index 32 shown in FIG. 7(b). At that time, it is assumed that in consideration of keying errors and voice recognition errors at the time of the input, when making a comparison between character positions, determining that they match each other not only when there is a full match between them, but also when they are at a predetermined distance or less, e.g., at a distance equal to or less than two characters can be allowed. For example, although the character position of “IN” in the input character string 101 is the third character, <40, 4> appearing in “EDWIN” can be used for the comparison.

The word dictionary searcher adds up the number of character bigrams acquired from the index for each word number in the above-mentioned way, to determine the number as each similar word candidate's score. In the above-mentioned example of “EDINB”, a score of “4” is provided for each of “EDINBANE” (word number of 10) and “EDINBURGH” (word number of 20), a score of “3” is provided for “EDINGTON” (word number of 30), and a score of “2” is provided for “EDWIN” (word number of 40).

Next, the number-of-input-characters determinator 23 performs a process of determining the number of input characters of the input character string 101, and calculates the upper limit n on the number of similar word candidate acquisition candidates according to the result of the determination (step ST22). The upper limit n is calculated according to, for example, the following equation (1).

$$n = \{ \begin{matrix}i * 0.5 - 1 & ( i < 2 ) \\ 0 & ( i \geq 2 )\end{matrix} \qquad equation ( 1 )$$

In the equation (1), when the number i of input characters is small, the upper limit n is set to a larger value in such a way that a larger number of similar words can be covered. In contrast, when the number i of input characters is large, because the number of similar words becomes small, importance is placed on the speed performance in the name search process which will be mentioned below, and the upper limit n is set to a smaller value.

When the input character string 101 consists of a plurality of words, the number-of-input-words determinator 24 performs the process of determining the number of input words on the basis of the word numbers attached to the after-division input character string 105 inputted from the input character string divider 7, and calculates the upper limit n on the number of similar word candidate acquisition candidates according to the result of the determination (step ST23). The upper limit n is calculated according to, for example, the following equation (2).

n=1000*log(w*10000) equation (2)

In the equation (2), when the word number w is small, it is assumed that there are few input errors and the upper limit n is set to a smaller value. In contrast, when the word number w is large, it is assumed that an input error can occur and the upper limit n is set to a larger value.

The specific character string determinator 25 refers to the specific character string table 27, determines whether the input character string 101 matches a specific character string, and acquires the upper limit n on the number of similar word candidate acquisition candidates according to the result of the determination (step ST24). Concretely, when the input character string 101 matches a specific character string 27a in the specific character string table 27, the specific character string determinator acquires the corresponding specific character string candidate number upper limit 27b as the upper limit n on the number of similar word candidate acquisition candidates. As a result, for a specific character string having an extremely large number of similar word candidates, search omissions can be prevented. In contrast, for a character string having an extremely small number of similar word candidates, an excessive search process on similar words can be prevented from being performed, and the search process can be speeded up.

The CPU load determinator 26 performs a process of acquiring a value showing the CPU load (arithmetic load) on the search device 100 at this time to determine the level of the CPU load, and calculates the upper limit n on the number of similar word candidate acquisition candidates according to the result of the determination (step ST25). The upper limit n is calculated according to, for example, the following equation (3). In this case, it is assumed that the value showing the CPU load is larger than 0.0 and is smaller than 1.0.

n=(1.0−(CPU load))*1000 equation (3)

In the equation (3), if in a state in which the CPU load is high, in order to prevent the time required for the search process from becoming long, the upper limit n is set to a smaller value. In contrast with this, if in a state in which the CPU load is low, in order to reduce search omissions, the upper limit n is set to a larger value.

The number-of-similar-word-candidates controller 22 sets the final upper limit N on the number of similar word candidate acquisition candidates according to the results of the processes of steps ST22 to ST25 (step ST26). In this case, the upper limit n on the number of similar word candidate acquisition candidates set in each of steps of ST22 to ST25 is stored in a storage area (not shown), and the stored values are compared with each other and the minimum or the maximum of them is set as the final upper limit N on the number of similar word candidate acquisition candidates. As an alternative, the average of the stored values can be set as the final upper limit N on the number of similar word candidate acquisition candidates. Even though a concrete means for determining the final upper limit N on the number of similar word candidate acquisition candidates is any type of means, the concrete means does not impair the features of the present invention.

The number-of-similar-word-candidates controller 22 selects the top N search results having a higher score from among the search results provided in step ST21 according to the final upper limit N on the number of similar word candidate acquisition candidates set in step ST26, to generate and output a similar word candidate list 102 (step ST27). The above-mentioned operation is the one of the similar word candidate acquirer 2.

Next, the details of the similar word selector 4 will be explained.

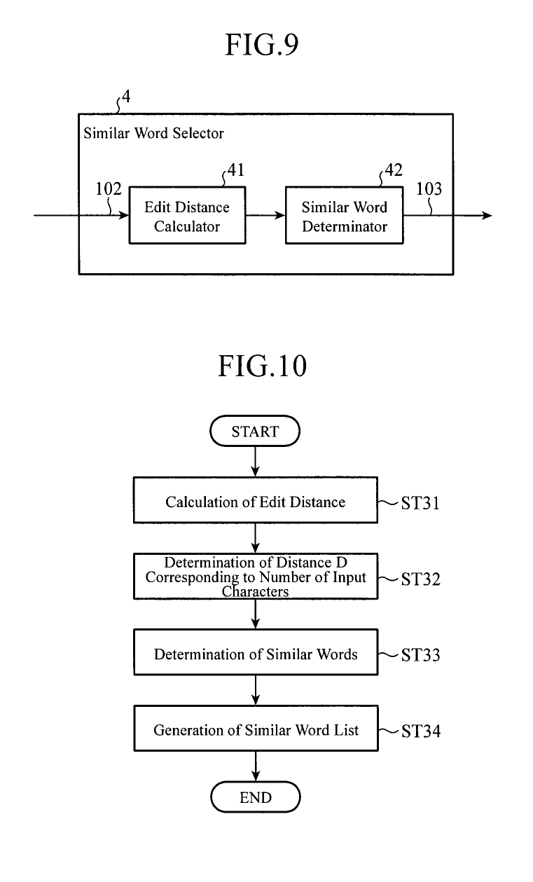

FIG. 9 is a block diagram showing the configuration of the similar word selector of the search device in accordance with Embodiment 1 of the present invention.

The similar word selector 4 is configured with an edit distance calculator 41 and a similar word determinator 42.

The edit distance calculator 41 calculates the edit distance between each of the words in the similar word candidate list 102, and the input character string 101. The similar word determinator 42 determines similar words on the basis of whether or not the distance which is determined according to the number of input characters is equal to or less than a predetermined distance. In this determining process, a similar word list 103 in which each word whose distance determined according to the number of input characters is equal to or less than the predetermined distance is listed as a similar word is generated and outputted.

FIG. 10 is a flow chart showing the operation of the similar word selector of the search device in accordance with Embodiment 1 of the present invention.

The edit distance calculator 41 calculates the edit distance between each of the words in the similar word candidate list 102, and the input character string 101 (step ST31). For the calculation of the edit distance, a typical method of using dynamic programming is known, and the explanation of this method will be omitted hereafter by assuming that this method is used.

Next, the similar word determinator 42 determines a predetermined distance D which is a threshold determined according to the number i of input characters of the input character string 101 according to, for example, the following equation (4) (step ST32).

$$D = \{ \begin{matrix}0 & ( i < 2 ) \\ i * 0.3 & ( i \geq 2 )\end{matrix} \qquad equation ( 4 )$$

Further, the similar word determinator 42 performs a similar word determining process of determining whether or not the edit distance calculated in step ST31 is equal to or less than the predetermined distance D determined in step ST32 (step ST33). On the basis of the similar word determination results of step ST33, the similar word determinator selects similar word candidates each of which has an edit distance equal to or less than the predetermined distance D, to generate and output a similar word list 103 (step ST34). The above-mentioned process is the one of the similar word selector 4.

Next, the details of the name searcher 5 and the name search index data storage 6 will be explained.

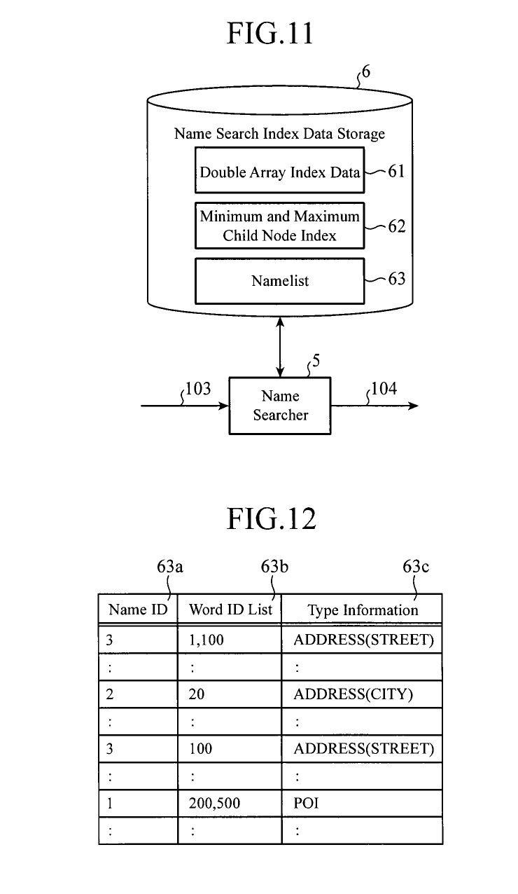

FIG. 11 is a block diagram showing the configuration of the name searcher and the name search index data storage of the search device in accordance with Embodiment 1 of the present invention.

The name searcher 5 refers to the name search index data storage 6, searches for name data including each of the words included in the similar word list 103, and outputs the name data as search result data 104. It is assumed that the name searcher 5 uses a search method disclosed in the following reference 1 as a search method. Because the details of the search method are described in reference 1, an outline of the search process will be shown hereafter. Reference 1: Japanese Unexamined Patent Application Publication No. 2010-205119

The name search index data storage 6 is configured with double array index data 61, a minimum and maximum child node index 62, and a namelist 63.

The double array index data 61 is data in which a Base array and a Check array in a double array method are stored. The minimum and maximum child node index 62 is data in which an array having, as its values, an internal code for making a transition to a character string which is a minimum in the alphabetical order, and an internal code for making a transition to a character string which is a maximum in the alphabetical order. The namelist 63 is data which the character strings of names registered are sorted and stored in the alphabetical order.

The name searcher 5 searches for a node corresponding to the search string provided therefor on the basis of the double array index data 61. The name searcher then searches through the child nodes of the nodes which are searched for, for both a node which is a minimum character string in the alphabetical order and a node which is a maximum character string in the alphabetical order, on the basis of the minimum and maximum child node index 62. In addition, the name searcher refers to the namelist 63, and extracts all names including from the name corresponding to the minimum node, which is searched for, to the name corresponding to the maximum node, which is searched for, and determines all the names as search result data 104.

FIG. 12 is a diagram showing an example of the namelist stored by the name search index data storage of the search device in accordance with Embodiment 1 of the present invention.

It is assumed that the namelist 63 is configured with name IDs 63a each of which determines at least a name uniquely, word ID lists 63b each of which is an ID list of a word which constructs a name, and pieces of type information 63c each of which is type information of a word which constructs a name. In this case, a word ID list 63b is a list of the word number of each word, and is the same as a word number 31a in a one-to-one correspondence with a word character string 31b in the word character string table 31 shown in FIG. 7(a).

In order to display the search result data 104 by using this namelist 63, the word character string table 31 of FIG. 7(a) is referred to, and the word ID lists 63 are converted into general word character strings. In the example of FIG. 12, two rows each having the same name ID of “3” are shown. This is because in order to make it possible to search for a name which consists of a plurality of words (word numbers of 1 and 100), starting from a word midway in the name, the name is expanded in advance to generate indices.

Although the search method using a double array index described in reference 1 is shown above as an example, any search method can be applied properly to the name search process performed by the name searcher 5 as long as the method is a one of searching for name data including each word included in the similar word list 103 at a high speed. For example, a database used for embedded equipment can be used, or a configuration can be provided in which the information which the namelist 63 of the name search index data storage 6 has is embedded in tree structure index data used for making a search at a high speed.

As mentioned above, because the search device in accordance with this Embodiment 1 is configured to include: the similar word candidate acquirer 2 to set an upper limit N on the number of similar word candidate acquisition candidates by using the number-of-similar-word-candidates controller 22, and acquire similar word candidates whose number is equal to the upper limit N set thereby; the similar word selector 4 to select similar words on the basis of the calculation of the edit distance between each acquired similar word candidate and the input character string; and the name searcher 5 to search for names each including one of the selected similar words, the search device can adjust the number of similar word candidates according to the conditions, such as the number of input characters and the number of input words, and can reduce search omissions and can implement a high-speed search process.

Further, because the number-of-similar-word-candidates controller 22 in accordance with this Embodiment 1 is configured in such a way as to set the final upper limit N on the basis of the upper limit n on the number of similar word candidate acquisition candidates which is calculated by using the determination result provided by the number-of-input-characters determinator 23, the upper limit N on the number of similar word candidates can be set to be large for an input of a small number of characters which increases the ambiguity, and search omissions can be prevented. In contrast, for an input of a large number of characters which decreases the ambiguity, the upper limit N on the number of similar word candidates can be set to be small, and the performance of search speed can be improved.

Further, because the number-of-similar-word-candidates controller 22 in accordance with this Embodiment 1 is configured in such a way as to set the final upper limit N on the basis of the upper limit n on the number of similar word candidate acquisition candidates which is calculated by using the determination result provided by the number-of-input-words determinator 24, the upper limit N on the number of similar word candidates can be set to be large for a word which increases the ambiguity and which is inputted lastly in the input order, and search omissions can be prevented. In contrast, for a word which decreases the ambiguity and which is inputted first in the input order, the upper limit N on the number of similar word candidates can be set to be small, and the performance of search speed can be improved.

Further, because the number-of-similar-word-candidates controller 22 in accordance with this Embodiment 1 is configured in such a way as to set the final upper limit N on the basis of the upper limit n on the number of similar word candidate acquisition candidates which is calculated by using the determination result provided by the specific character string determinator 25, the upper limit N on the number of similar word candidates can be set individually for a specific character string, and either a setting of placing importance on the prevention of search omissions or a setting of placing importance on the speed performance can be performed as needed.

Further, because the number-of-similar-word-candidates controller 22 in accordance with this Embodiment 1 is configured in such a way as to set the final upper limit N on the basis of the upper limit n on the number of similar word candidate acquisition candidates which is calculated by using the determination result provided by the CPU load determinator 26, the upper limit N on the number of similar word candidates can be set according to the CPU load, and either a setting of placing importance on the prevention of search omissions or a setting of placing importance on the speed performance can be performed as needed.

Although the configuration in which the number-of-similar-word-candidates controller 22 includes the number-of-input-characters determinator 23, the number-of-input-words determinator 24, the specific character string determinator 25, and the CPU load determinator 26 is shown in above-mentioned Embodiment 1, what is necessary is just to include at least either one of the determinators, and the determinator to be disposed can be selected properly.

### Embodiment 2

In this Embodiment 2, a configuration will be explained in which prevention of search omissions is also performed on an input character string which is difficult to be searched for through a typical character bigram search due to keying errors or voice recognition errors.

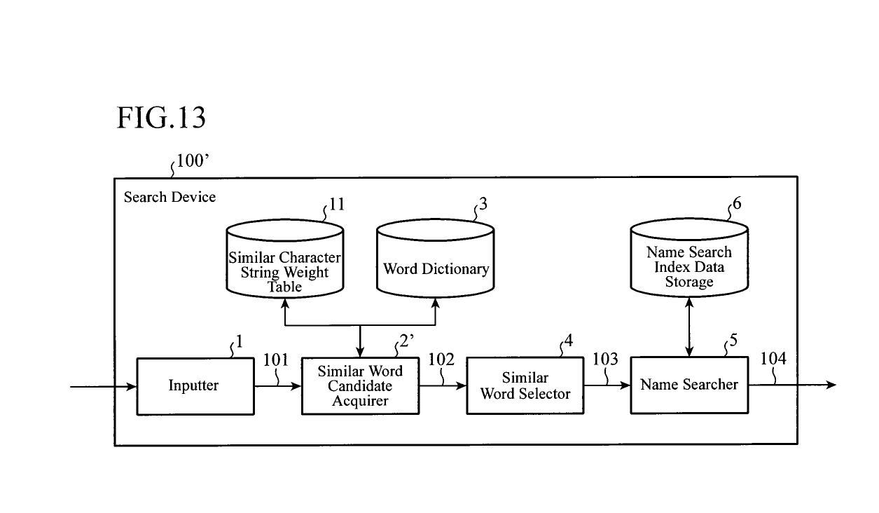

FIG. 13 is a block diagram showing the configuration of a search device in accordance with Embodiment 2 of the present invention.

The search device 100′ in accordance with Embodiment 2 additionally includes a new internal structure in the similar word candidate acquirer 2 of the search device 100 in accordance with Embodiment 1 shown in FIG. 1, and further additionally includes a similar character string weight table 11. Hereafter, the same components as those of the search device 100 in accordance with Embodiment 1 or like components are denoted by the same reference numerals as those used in Embodiment 1, and the explanation of the components will be omitted or simplified.

A similar word candidate acquirer 2′ refers to the similar character string weight table 11 and a word dictionary 3, to generate a similar word candidate list 102.

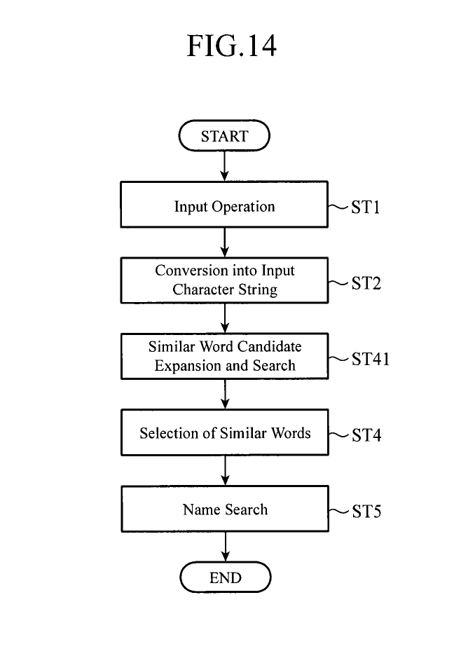

FIG. 14 is a flow chart showing the operation of the search device in accordance with Embodiment 2 of the present invention. Hereafter, the same steps as those of the search device 100 in accordance with Embodiment 1 are denoted by the same reference characters as those used in FIG. 2, and the explanation of the steps will be omitted or simplified.

When an inputter 1, in step ST2, converts an input operation into a input character string 101, the similar word candidate acquirer 2′ refers to the similar character string weight table 11 and the word dictionary 3 and performs a similar word candidate expansion search process on the input character string 101, to acquire similar word candidates and generate a similar word candidate list 102 (step ST41).

At that time, in order to also enable an input for a complement to a word, the similar word candidate acquirer refers to the word dictionary and performs an ambiguous comparison based on prefix search priority to acquire similar word candidates. The word dictionary is generated by dividing each name data which is a search target into words in advance and removing redundancy. In the similar word candidate expansion search process of step ST41, the similar word candidate acquirer retrieves similar word candidates according to an algorithm whose amount of computations is smaller than that of an edit distance calculation and which can speed up the process. The details of the similar word candidate acquisition processing of step ST41 will be mentioned below. After that, processes of steps ST4 and ST5 are performed and the search process is ended, like in the case of Embodiment 1.

Next, the details of similar word candidate acquirer 2′ will be explained.

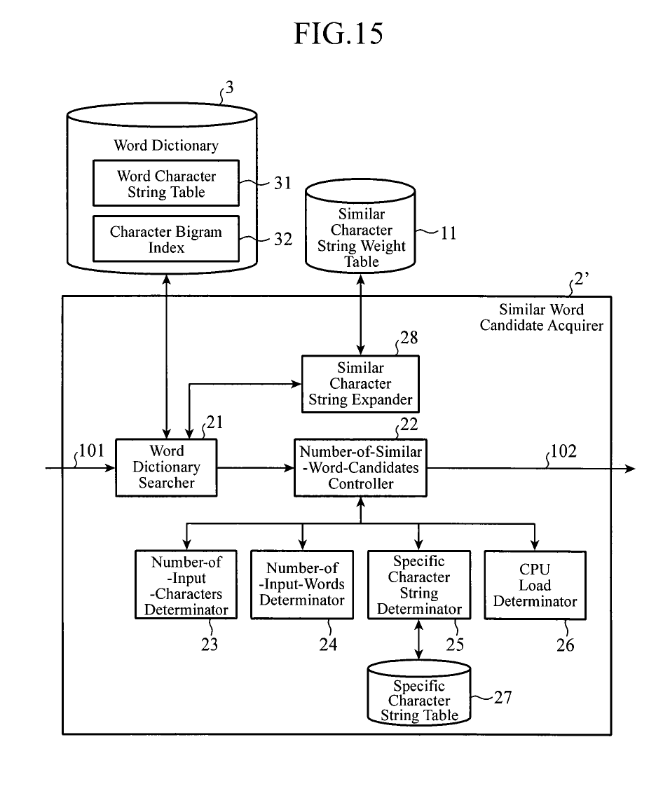

FIG. 15 is a block diagram showing the configuration of the similar word candidate acquirer of the search device in accordance with Embodiment 2 of the present invention. The similar word candidate acquirer 2′ in accordance with Embodiment 2 additionally includes a similar character string expander 28 in addition to the configuration of the similar word candidate acquirer 2 in accordance with Embodiment 1. Hereafter, the same components as those of the similar word candidate acquirer 2 in accordance with Embodiment 1 or like components are denoted by the same reference numerals as those used in Embodiment 1, and the explanation of the components will be omitted or simplified.

The similar character string expander 28 refers to the similar character string weight table 11, and expands character bigrams for word dictionary search which the word dictionary searcher 21 has generated on the basis of the input character string 101.

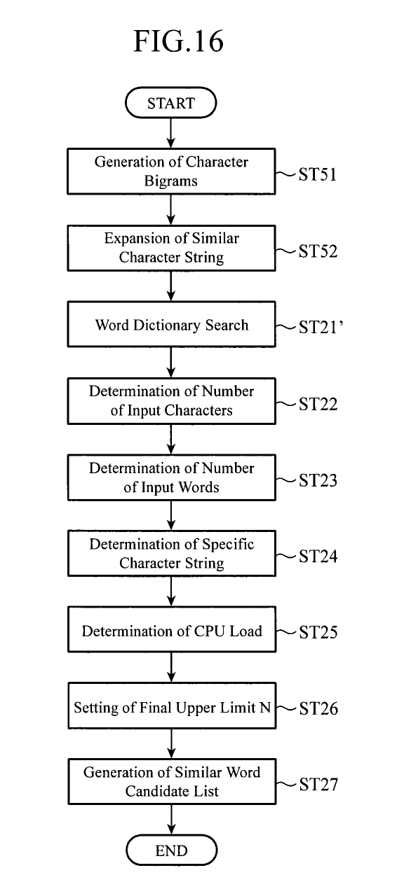

FIG. 16 is a flow chart showing the operation of the similar word candidate expansion searcher of the search device in accordance with Embodiment 1 of the present invention.

Hereafter, the same steps as those of the similar word candidate acquirer 2 of the search device 100 in accordance with Embodiment 1 are denoted by the same reference characters as those used in FIG. 8, and the explanation of the steps will be omitted or simplified.

The word dictionary searcher 21 generates character bigrams for word dictionary search on the basis of the input character string 101 (step ST51). For example, when the input character string 101 is “XYC”, “XY” and “YC” are generated as the character bigrams for word dictionary search. The similar character string expander 28 refers to the similar character string weight table 11, and expands the character bigrams for word dictionary search generated in step ST51 (step ST52).

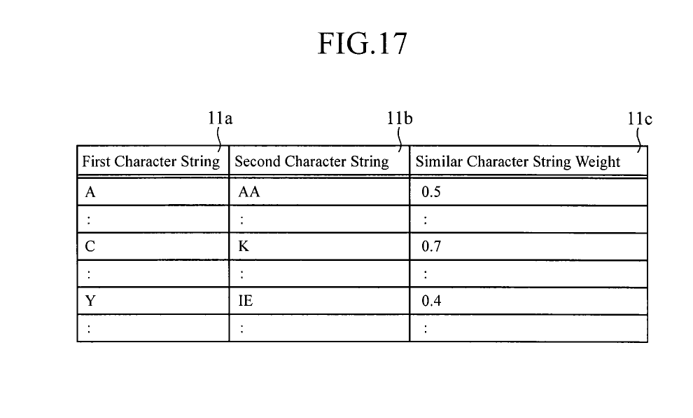

An example of the configuration of the similar character string weight table 11 is shown in FIG. 17. The similar character string weight table 11 defines combinations of character strings or the likes, which are easy to have keying errors and voice recognition errors, with weights, and each combination consists of at least a first character string 11a, a second character string 11b, and a similar character string weight 11c. For example, the character bigrams “XY” and “YC” which are generated in the above-mentioned explanation are expanded into “XIE” (weight of 0.4) and “YK” (weight of 0.7), respectively.

Next, the word dictionary searcher 21 searches through the word dictionary 3 on the basis of, in addition to the character bigrams of the input character string 101, the character bigrams after the expansion in step ST52 (step ST21′).

Concretely, on the basis of, in addition to the character bigrams “XY” and “YC” of the input character string 101, the character bigrams “XIE” and “YK” after the expansion, a search on the word dictionary 3 is performed. As search scores in the search on the word dictionary 3, the similar character string weight 11c in the similar character string weight table 11 is used. More specifically, a weight of “0.4” is added to each document which is acquired from the word dictionary 3 by using “XIE” (weight of 0.4) as a search key. By performing a score calculation by using the similar character string weight 11c in this way, candidates each having a character bigram fully matching the input character string 101 can be searched for as similar word candidates on a priority basis.

After that, the similar word candidate expansion searcher 10 performs the same processes as those of steps ST22 to ST27 of Embodiment 1, to generate and output a similar word candidate list 102.

As mentioned above, because the search device in accordance with this Embodiment 2 is configured in such a way as to include the similar character string expander 28 to refer to the similar character string weight table 11 which defines combinations of character strings or the likes, which are easy to have keying errors and voice recognition errors, with weights, and expand similar character strings from character bigrams which the word dictionary searcher 21 has generated, the search device can perform a search process with few search omissions also on an input character string which is difficult to be searched for through a typical character bigram search due to keying errors or voice recognition errors.

### Embodiment 3

In this Embodiment 3, a configuration will be explained in which the number of times of a name search process is reduced, and the search process is speeded up.

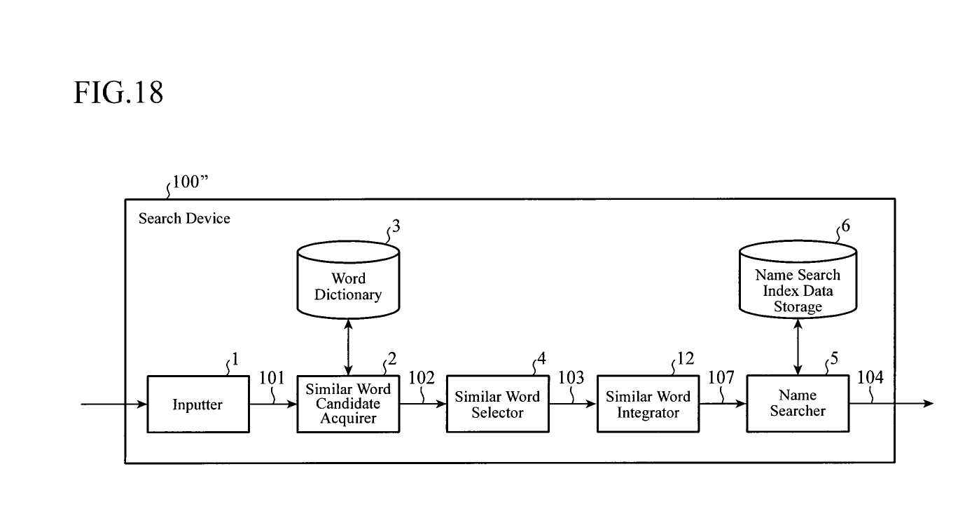

FIG. 18 is a block diagram showing the configuration of a search device in accordance with Embodiment 3 of the present invention.

The search device 100″ in accordance with Embodiment additionally includes a similar word integrator 12 in addition to the search device 100 in accordance with Embodiment 1 shown in FIG. 1. Hereafter, the same components as those of the search device 100 in accordance with Embodiment 1 or like components are denoted by the same reference numerals as those used in Embodiment 1, and the explanation of the components will be omitted or simplified.

The similar word integrator 12 performs a similar word integrating process on the basis of an input character string 101 and a similar word list 103, and generates a prefix matched similar word list 107.

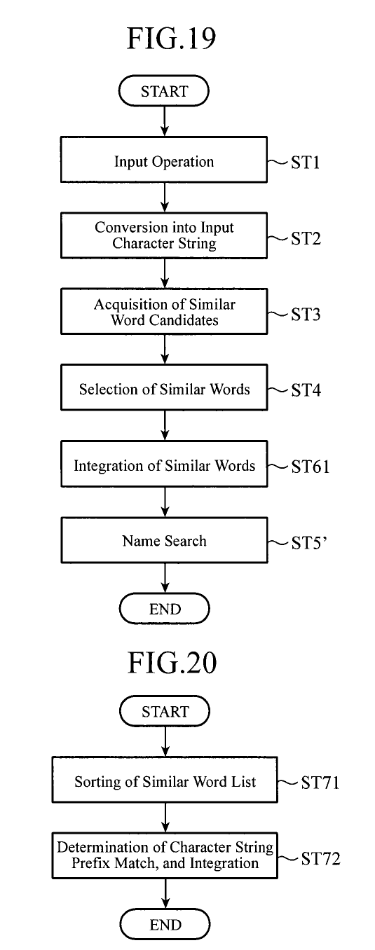

FIG. 19 is a flow chart showing operation of the search device in accordance with Embodiment 3 of the present invention. Hereafter, the same steps as those of the search device 100 in accordance with Embodiment 1 are denoted by the same reference characters as those used in FIG. 2, and the explanation of the steps will be omitted or simplified.

When a similar word selector 4, in step ST4, generates the similar word list 103, the similar word integrator 12 performs a similar word integrating process on the basis of both this similar word list 103 and the input character string 101 after the conversion in step ST2, to generate a prefix matched similar word list 107 (step ST61). The details of the similar word integrating process of step ST61 will be mentioned below.

After that, a name searcher 5 searches for name data including one word in the prefix matched similar word list 107 generated in step ST61, outputs the name data as search result data 104 (step ST5′), and ends the process.

Next, the details of the similar word integrator 12 will be explained.

FIG. 20 is a flow chart showing the operation of the similar word integrator of the search device in accordance with Embodiment 3 of the present invention.

The similar word integrator 12 sorts the similar word list 103 which the similar word selector 4 has generated in the order of the character strings (step ST71). The similar word integrator then performs a comparison with the input character string 101 sequentially from the top of the sorted similar word list 103, determines whether each similar word has characters whose number is equal to or larger than that of the input character string 101 and has a leading character string matching the input character string, and integrates matched similar words (step ST72).

Concretely, for example, when the input character string 101 is “EDIN”, and “EDINBANE” and “EDINBURGH” exist in the similar word list 103, because the number of characters of the input character string 101 is four, the words each of whose leading four characters match the input character string are integrated, as similar words, to provide “EDIN.”

By integrating, as similar words, the words each of whose character string matches the input character string 101 in this way, the number of times of the name search process which the name searcher 5 in a stage next to the similar word integrator 12 performs can be reduced, and the search process is speeded up.

Although because the name search process shown in step ST5 of the flow chart of FIG. 19 is the same as that in accordance with Embodiment 1, a detailed explanation of the name search process will be omitted hereafter, because in the name search process of step ST5, a prefix search is performed by using each word in the prefix matched similar word list 107 inputted from the similar word integrator 12, search results provided using the character string “EDIN” integrated in above-mentioned steps ST71 and ST72 match results of having made a search by using all the similar words starting from “EDIN”, such as “EDINBANE” and “EDINBURGH.”

As mentioned above, because the search device in accordance with this Embodiment 3 is configured in such a way as to include the similar word integrator 12 to perform a comparison between the similar word list and the input character string, integrate similar words each of whose leading character string matches the input character string, the leading character string having characters whose number is equal to that of the input character string, and generate a prefix matched similar word list, the number of times of the name search process of performing a name search on the basis of the prefix matched similar word list is reduced, and a speedup of the search process can be implemented.

Although in above-mentioned Embodiments 2 and 3, the case in which the input character string is one word or a partial character string of one word is explained as an example, the input character string can be a plurality of words or a partial character string of a plurality of words, like in the case of Embodiment 1. In that case, the configuration shown in the block diagram of FIG. 2 of Embodiment 1 and the process shown in the flow chart of FIG. 4 can be applied.

While the invention has been described in its preferred embodiments, it is to be understood that an arbitrary combination of two or more of the above-mentioned embodiments can be made, various changes can be made in an arbitrary component in accordance with any one of the above-mentioned embodiments, and an arbitrary component in accordance with any one of the above-mentioned embodiments can be omitted within the scope of the invention.

### INDUSTRIAL APPLICABILITY

As mentioned above, the search device in accordance with the present invention can be applied to a navigation device that searches for a facility name or the like, and various devices that perform, for example, an address search, a search for an electronic manual, etc., and can implement a high-speed ambiguous search process in which search omissions are reduced.

### EXPLANATIONS OF REFERENCE NUMERALS

1 inputter, 2 and 2′ similar word candidate acquirer, 3 word dictionary, 4 similar word selector, 5 name searcher, 6 name search index data storage, 7 input character string divider, 8 number-of-yet-to-be-processed-words determinator, search result integrator, 11 similar character string weight table, 12 similar word integrator, 21 word dictionary searcher, 22 number-of-similar-word-candidates controller, 23 number-of-input-characters determinator, 24 number-of-input-words determinator, 25 specific character string determinator, 26 CPU load determinator, 27 specific character string table, 28 similar character string expander, 31 word character string table, 32 character bigram index, 41 edit distance calculator, 42 similar word determinator, 61 double array index data, 62 minimum and maximum child node index, 63 namelist, 100, 100′, and 100″ search device, 101 input character string, 102 similar word candidate list, 103 similar word list, 104 search result data, 105 after-division input character string, 106 integrated search result data, and 107 prefix matched similar word list.

1. A search device that performs a search process by using, as a search key, an input character string including ambiguity, to acquire a search text, said search device comprising:
a word dictionary to store word character string data about each of words into which said search text is divided;
a similar word candidate acquirer including a word dictionary searcher to perform a comparison between said input character string and word character string data stored in said word dictionary, and search for word character string data similar to said input character string to acquire, as similar word candidates, the word character string data which have been searched for, and a number-of-similar-word-candidates controller to select similar word candidates from the similar word candidates acquired by said word dictionary searcher according to a preset threshold;
a similar word selector to calculate an edit distance between each of the similar word candidates selected by said number-of-similar-word-candidates controller and said input character string, and select, as a similar word, a similar word candidate whose calculated edit distance is equal to or less than a predetermined distance;
a search index data storage to store said search text; and
a text searcher to refer to said search index data storage to search for a search text including the similar word selected by said similar word selector,
wherein said similar word candidate acquirer includes a number-of-input-characters determinator to determine whether a number of characters of said input character string is large or small, and calculate said threshold according to a result of the determination.

2. (canceled)

3. The search device according to claim 1, wherein said similar word candidate acquirer includes a number-of-input-words determinator to, when said input character string consists of a plurality of words, determine whether a number of words of said input character string is large or small, and calculate said threshold according to a result of the determination.

4. The search device according to claim 1, wherein said similar word candidate acquirer includes a specific character string determinator to determine whether said input character string matches a specific character string which is preset, and acquire said threshold corresponding to a result of the determination.

5. The search device according to claim 1, wherein said similar word candidate acquirer includes an arithmetic load determinator to acquire an arithmetic load on said search device, determine whether said arithmetic load is high or low, and calculate said threshold according to a result of the determination.

6. The search device according to claim 1, wherein said search device includes a similar character string weight table to define combinations of similar character strings, and said similar word candidate acquirer includes a similar character string expander to refer to said similar character string weight table to expand said input character string to similar character strings, and wherein said word dictionary searcher performs a comparison between said input character string and the similar character strings after the expansion by said similar character string expander, and the word character string data stored in said word dictionary, and searches for word character string data similar to said input character string and said similar character strings after the expansion, to acquire the word character string data as said similar word candidates.

7. The search device according to claim 1, wherein said search device includes a similar word integrator to compare each of similar words selected by said similar word selector with said input character string, search through said similar words for a plurality of similar words each of whose leading character string matches said input character string, and integrate the plurality of similar words which said similar word integrator has searched for into a similar word, and wherein said text searcher refers to said search index data storage, and searches for a search text including the similar word after the integration by said similar word integrator.

8. The search device according to claim 1, wherein said search device includes:
an input character string divider to, when said input character string consists of a plurality of words, generate an after-division input character string in which said input character string is divided on a per word basis;
a number-of-yet-to-be-processed-words determinator to determine whether processes of said similar word candidate acquirer, said similar word selector, and said text searcher are performed on all character strings of said after-division input character string on a basis of a search text which said text searcher has searched for; and
a search result integrator to, when said number-of-yet-to-be-processed-words determinator determines that said processes have been performed on all the character strings of said after-division input character string, integrate search texts which said text searcher has searched for.
